(19) United States
(12) Patent Application Publication
(10) Pub. No.: US 2010/0058085 A1
(43) Pub. Date: Mar. 4, 2010

(54) Power-Saving Device and Method

(75) Inventors: Chih-Ching Chien, Hsinchu County (TW); Ying-Hui Zhu, Suzhou City (TW); Wen-Bin Wu, Suzhou City (TW); Yong-Peng Jing, Suzhou City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: REALTEK SEMICONDUCTOR CORP., HsinChu (TW)

(21) Appl. No.: 12/542,262

(22) Filed: Aug. 17, 2009

(30) Foreign Application Priority Data
Sep. 3, 2008 (TW) 97133787

(51) Int. Cl. G06F 13/00; G06F 1/32

(52) U.S. Cl. 713/320; 710/107

(57) ABSTRACT

A power-saving device and method are applicable to a first electronic device having at least one connection interface, and the first electronic device is coupled to a second electronic device via a bus. The power-saving device includes a detection circuit, a power control circuit, and a connection control circuit. The detection circuit is coupled to the connection interface, to detect a load state of the connection interface and generate a detection signal. The power control circuit controls power supplied to the first electronic device via the bus in response to a state of the detection signal. The connection control circuit controls a connection state of the bus according to the detection signal.

### CROSS-REFERENCES TO RELATED APPLICATIONS

This application claims priority under 35 U.S.C. §119(a) to Taiwan patent application No. 97133787, filed in Taiwan, R.O.C. on Sep. 3, 2008, the entire contents of which are hereby incorporated by reference.

### BACKGROUND OF THE INVENTION

1. Field of the Invention

The present invention generally relates to electronic devices, and in particular to a power-saving device and method applicable to a peripheral electronic device.

2. Related Art

As technology continues to advance, more and more portable electronic products are being used by more and more people. Various connection standards have been developed to allow portable electronic devices to communicate with host and other electronic devices. The Universal Serial Bus (USB), peripheral component interconnect (PCI), and PCI Express (PCI-E) busses are just three examples of such connection (or bus) standards. General design goals of these ever-developing bus standards are wide transmission bandwidth, low power consumption, and the ability to support a hot-plug function (e.g., the connection of an electronic device with a host device, after the host device is powered up).

As is known, these design goals are often competing, or conflicting. For example, faster communication rates generally demand higher power consumption. Indeed, as the buses are becoming more and more diversified with an ever-growing speed, the power consumption thereof is increased. Moreover, as the electronic products are becoming smaller and more portable, the issue of power consumption becomes increasingly important. In this regard, many portable electronic devices are battery operated. As power demands increase, then battery life decreases. In addition, to reduce the size and weight of electronic devices, it is desired to reduce the battery size, yet as battery size is reduced, so too is the length that it can sustain its charge. Further, power generally translates to heat (which must be dissipated from the device). As device size is reduced, the temperature of the device will generally increase (if power remains constant).

In order to reduce the power consumption of electronic products, many bus products adopt a power-saving mode in their design, for example, a suspended state of the USB or an active state power management (ASPM) of the PCI-E. Further, to achieve lower power consumption, drivers are generally required in the power-saving modes to provide strong support, and many of the drivers are developed by manufactures of the bus products themselves.

In view of the above, it is convenient to utilize a dynamic power saving by using the drivers. However, in the application of a computer system, several products that share the same bus frequently exist, for example, an electronic device having USB interface and a memory card slot, a monitor, a cell phone, a PDA, a DSC, a USB PC camera, a USB card reader, or USB flash memory. Therefore, if the power saving function is merely achieved through the drivers, problems with computer compatibility may occur, and the operating system (OS) of the computer may even freeze or hang up. This being the case, it is difficult for the manufactures of bus products to completely solve the problem of compatibility and stability, thus resulting in product development delays.

Further, if only the OS inbox drivers are used, power saving functions may not be achieved. Therefore, at least in the area of portable devices, the power consumption is a significant problem, and it is desired to identify better solutions to this problem.

### SUMMARY OF THE INVENTION

Accordingly, the present invention is directed to an improved power management system for an electronic device. According to application properties of a bus product, the connection between the bus product and a second electronic device is dynamically controlled through hot-plug characteristics of a bus interface, so as to further save power. By realizing active dynamic power saving directly through a hardware device without using any drivers, the compatibility problem in the prior art can be reduced.

A power-saving device is applicable to a first electronic device having at least one connection interface, and the first electronic device is coupled to a second electronic device via a bus. The power-saving device includes a detection circuit, a power control circuit, and a connection control circuit. The detection circuit is coupled to the connection interface, to detect a load state of the connection interface and generate a detection signal. The power control circuit controls power supplied to the first electronic device via the bus in response to a state of the detection signal. The connection control circuit controls a connection state of the bus according to the detection signal.

A power saving method is also applicable to a first electronic device having at least one connection interface, and the first electronic device is coupled to a second electronic device via a bus. The power saving method includes: detecting a load state of the connection interface, and generating a detection signal; controlling a power supplied to the first electronic device via the bus according to the detection signal; and controlling a connection state of the bus according to the detection signal.

Preferred embodiments of the present invention and efficacies thereof will be illustrated in detail below with the accompanying drawings.

### BRIEF DESCRIPTION OF THE DRAWINGS

The present invention will become more fully understood from the detailed description given herein below for illustration only, and thus are not limitative of the present invention, wherein:

FIG. 1 is a diagram of an application of a power-saving device constructed in accordance with an embodiment of the invention;

FIG. 2 is a diagram of an embodiment of a power-saving device according to a first embodiment of the present invention;

FIG. 3 is a diagram of an embodiment of a power-saving device according to a second embodiment of the present invention; and

FIG. 4 is a flow chart of a method for operating a power-saving device, in accordance with an embodiment of the invention.

### DETAILED DESCRIPTION OF EMBODIMENTS OF THE INVENTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

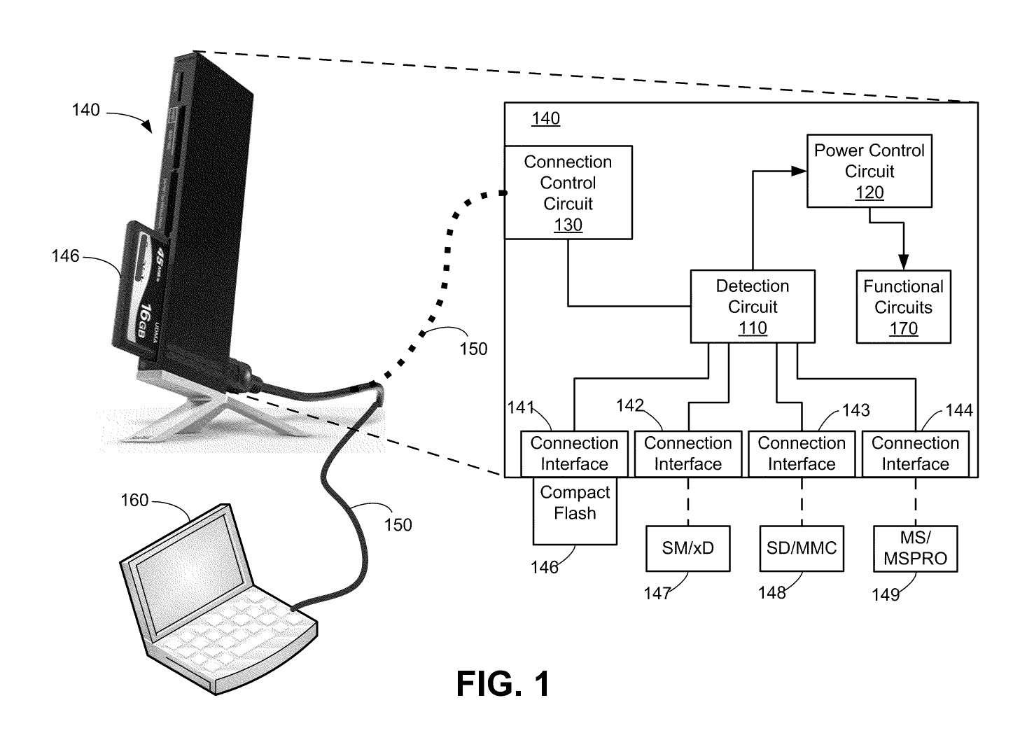

To illustrate certain embodiments of the present invention in the context of a particular application, reference is made to FIG. 1, which is a diagram illustrating a computer 160, such as a notebook computer, coupled to a memory card reader 150. In the illustrated embodiment, the memory card reader 150 has multiple slots for receiving memory cards of different formats, such as Compact Flash (CF), Secure Digital (SD), MultiMedia Card (MMC), Memory Stick (MS), and Memory Stick Pro (MS Pro). Of course, slots for other formats may also be provided. Similarly, in other embodiments, a card reader having only a single slot for a single memory format may be provided. As is known, when one or more memory cards is inserted in one of the slots, data may be transferred between the computer 160 and the inserted memory card(s) 146.

Data transfers between the computer 160 and memory card(s) 146 take place across a cable or connection bus 150. Consistent with embodiments of the invention, the connection bus may be USB, PCI, PCI-E, or any of a number of other bus formats or communication protocols.

On aspect of embodiments of the present invention relates to the operation of a peripheral electronic device, like the memory card reader 140, at lower power. As is known, the memory card reader 140 has internal circuitry that controls or manages the transfer of data between an inserted memory card 146 and the host computer 160. This internal circuitry, in prior art devices, remains powered up whenever the memory card reader 140 is connected to the computer 160. In this regard, the memory card reader generally receives its power via the connecting bus 150, and thus is typically powered by the host computer.

Power management is improved in embodiments of the present invention by detecting conditions in which power is not needed to be supplied to the peripheral device, and placing operational circuitry of the peripheral device in a low-power, suspended, or even off state (depending upon the application or embodiment).

To describe this feature in more detail, FIG. 1 also shows a block diagram of certain basic, functional circuit components in the card reader 140. In this regard, in addition to showing a drawing of the actual physical memory card reader 140, FIG. 1 also shows a block diagram of the card reader 140 and internal circuit components. These basic internal circuit components include a detection circuit 110, power control circuit 120, connection control circuit 130, and functional circuits 170. The functional circuits 170 block generically represents the on-device circuitry that is performs whatever functions are to be carried out by the peripheral device. In the case of a memory card reader 140, such functional circuitry would generally include buffer memory, a processing unit or DMA (direct memory access) manager, etc.). As the present invention is directed to the power management of such devices, the actual function(s) performed by the functional circuitry, and indeed details of the functional circuitry 170 are immaterial, and therefore are not described herein. All that is relevant for purposes of describing the inventive embodiments is that the power-management circuitry of the present invention is operative to controllably manage the functional circuitry 170 among a normal operation and low-power (or even off) operational modes.

In the illustrated embodiment, there are multiple slots for receiving a plurality of memory cards of differing formats. A separate connection interface 141, 142, 143, and 144 is provided for each slot, and serves to physically connect the conductive or I/O contacts of each type of memory card to the on-board circuitry of the peripheral device.

In short, a detection circuit 110 is provided and configured to monitor the connection interfaces for the presents of a corresponding memory card. If no memory card is inserted in any of the slots, then no data transfers will take place between the host computer 160 and the card reader 140. As such, there is no need for the functional circuitry of the card reader 140 to remain in a normal mode of operation. Accordingly, the circuitry may be placed in stand-by, low power state, and may even be powered down completely (until needed). Detection of the insertion of a memory card may be made in any of a variety of ways. For example, in one embodiment, current draw (or load) to some of the contact pins of the connection interfaces 141, 142, 143, and 144 may be monitored. If there is no current draw, then no memory card is inserted. Similarly, the detection circuit may be configured to measure or monitor impedance of (or impedance across) one or more contact pins of the connection interfaces. In yet another embodiment, a mechanical switch may be designed to be opened and closed upon the insertion and removal of memory cards in the various slots. The state of such a switch could be detected and monitored by the detection circuit 110 to determine whether a memory card has been inserted.

When no memory cards are inserted into any of the receiving slots, the detection circuits sends an appropriate signal to the power control circuit 120 (or otherwise the power control circuit senses an appropriate state of the detection circuit 110), and the power control circuit 120 places the functional circuitry 170 of the card reader 140 into an appropriate state for low-power operation.

Similarly, the connection control circuit 130 responds to an appropriate signal (or state) of the detection circuit 110 to place the interface bus 150 in a low-power mode of operation (such as an off-line mode). The specific mode that the bus is place in will vary depending upon the standard of the bus (e.g., USB, PCI, etc.). By placing the bus 150 in an offline mode, minimal power is drawn from (or consumed by) the host computer 160, even though the card reader 140 remains plugged into the computer 160.

It will be appreciated that, by minimizing the power required and consumed by a peripheral electronic device, like the memory card reader 140 of FIG. 1, minimal power will be consumed from the host computer 160, which is particularly important when the computer 160 is operating from battery power itself. In addition, minimizing the power consumption of the card reader 140 will keep the card reader 140, generally, at lower temperatures.

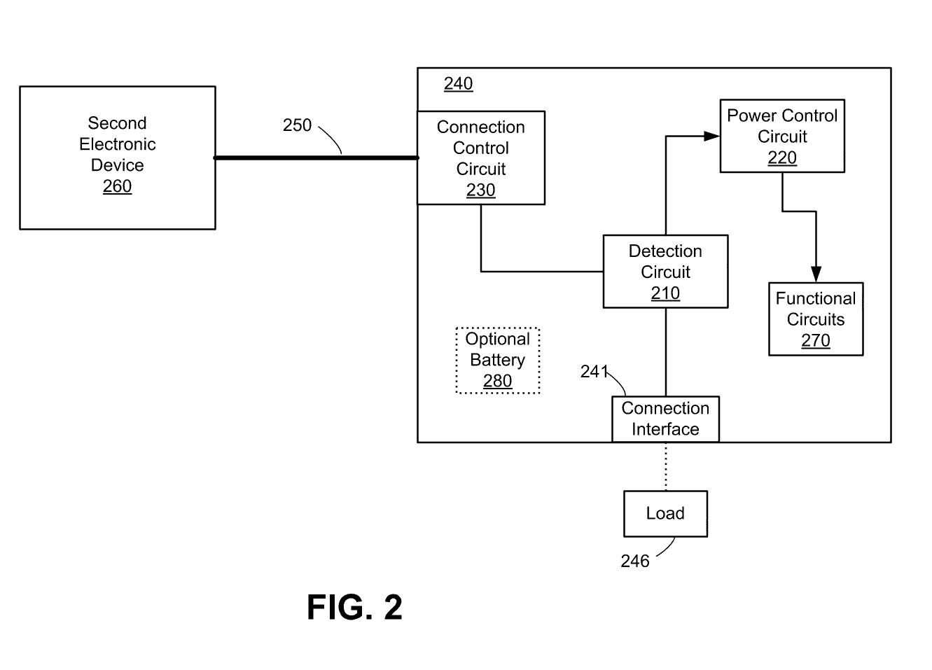

Having described one particular application of embodiments of the present invention, reference is now made to FIG. 2, which is a diagram showing a more generic application of embodiments of the present invention. In this more generic illustration, the peripheral electronic device (card reader) of FIG. 1 is more generically referred to as a first electronic device 240, and the host computer of FIG. 1 is more generically referred to as a second electronic device 260. This embodiment, indeed, presents a more meaningful illustration of embodiments of the present invention, as the broader power-management features of the present invention are applicable to a wide variety of electronic devices and not merely a host computer and a coupled memory card reader. As illustrated in FIG. 2, the power-saving device of embodiments of the present invention is applicable to a first electronic device 240 having at least one connection interface 242, and the first electronic device 240 is coupled to a second electronic device 260 via a bus 250. The power-saving device includes a detection circuit 210, a power control circuit 220, and a connection control circuit 230.

The detection circuit 210 is coupled to the connection interface 241, to detect a load state of the connection interface 241 and generate a detection signal. Such a detection signal may be an electrical signal output from the detection circuit 210, or simply may be a state of a signal on an internal circuit component of the detection circuit 210, which may be monitored or read by the power control circuit 220. The load state detects whether a load 246 is coupled to the connection interface 241 of the first electronic device 240. When no load 246 is coupled to the connection interface 241, it is indicated that the first electronic device 240 does not need to work (or consume power for its functional circuits 270) at present, and the device 240 thus enters a power-saving mode. As described above in connection with FIG. 1, the operation of the detection circuit 210 may be performed in a variety of ways to identify load versus no-load conditions of the load 246 via the connection interface 241, and these various ways will be appreciated by persons skilled in the art. Accordingly, details of the detection circuit are not described herein.

The power control circuit 220 controls power from the second electronic device 260 (e.g., host) supplied to the first electronic device 240 via the bus 250 according to the detection signal (or state) generated by the detection circuit 210. In response, the power control circuit 220 specifically powers off circuit units (e.g., functional circuits 270) in the first electronic device 240 that are not required to work when the first electronic device 240 enters the power-saving mode, so as to achieve an optimal power-saving efficiency. According to embodiments of the present invention, when the first electronic device 240 enters the power-saving mode, a small amount of power is provided to the detection circuit 210, such that only the detection circuit 210 continues to work normally, and the rest of the circuit units are all shut down. As will be appreciated by persons skilled in the art, the power control circuit 220 may be implemented in a variety of ways, and therefore detailed illustrations and discussions of such circuitry need not be described herein.

The connection control circuit 330 controls a connection state of the bus 250 according to the detection signal generated by the detection circuit 210 (or a state of the detection circuit). In one embodiment, the connection state is online or offline. When the load state is no-load, the connection control circuit 330 alters the connection state of the bus 250 between the first electronic device 240 and the second electronic device 260 so that it is offline—i.e., to enter a power-saving mode. In addition, when the load state is load on—i.e., the load 246 is coupled to the connection interface 241, the first electronic device 240 is required to work normally, and the connection control circuit 230 enables the first electronic device 240 to be coupled to the second electronic device 260 via the bus 250—i.e., to make the connection state of the bus 250 online. As will be appreciated by persons skilled in the art, the connection control circuit 230 may be implemented in a variety of ways, and therefore detailed illustrations and discussions of such circuitry need not be described herein.

In an embodiment, the bus 250 is a USB bus which comprises four wires (VDD, GND, DATA+, and DATA−), and the connection control circuit 230 includes a USB interface and a switch coupled between the first electronic device 240 and the second electronic device 260 to control the connection state of the USB bus 250. The switch is controlled by the detection signal from the detection circuit 210. When the load state is no-load, the switch of the connection control circuit 230 is OFF such that the USB bus is offline (i.e. the DATA+ and DATA− wires of the USB bus 250 between the first electronic device 240 and the second electronic device 260 are disconnected. When the load state is no-load, the switch of the connection control circuit 230 is ON such that the USB bus is online (i.e. the DATA+ and DATA− wires of the USB bus 250 between the first electronic device 240 and the second electronic device 260 are connected. In an embodiment, The VDD and GND wires of the USB bus 250 between the first electronic device 240 and the second electronic device 260 are always connected such that the second electronic device 260 can provide power to the first electronic device 240. In another embodiment, the first electronic device 240 includes a power circuit. For example, a battery 280 or power from a DC adapter (not shown) may be directly supplied to the first electronic device. In such an embodiment, detection power may be supplied to the detection circuit 210 by the battery 280 (or DC adapter) when the first electronic device 240 is operating in a low power mode, and the connecting bus 250 may be completely turned off. Otherwise, a slight power drawn from power lines of the bus 250 will be required to power the detection circuit 210 and the connection control circuit 230.

In an embodiment, the bus 250 is a PCI-E bus and the connection control circuit 230 includes a PCI-E interface and a switch coupled between the first electronic device 240 and the second electronic device 260 to control the connection state of the PCI-E bus 250.

The bus 250 may be, but is not limited to, a Universal Serial Bus (USB) or a Peripheral Component Interconnection Express (PCIE), as long as the bus 250 supports hot-plug. These embodiments utilize the hot-plug function of the bus 250 to achieve the objects of embodiments of this invention. When the first electronic device 240 (e.g., card reader), detects that there is no load coupled thereto via the detection circuit 210, it is indicated that the first electronic device 240 is not required to work. At this time, the first electronic device 240 actively enters the power-saving mode, and the connection state is offline such that the second electronic device 260 need not support the first electronic device 240. In this state, the first electronic device 240 can use a minimum power, and thus draw little to no power from the second electronic device 260.

When the first electronic device 240 (e.g., card reader), detects that there is load coupled thereto via the detection circuit 210, it is indicated that the first electronic device 240 is required to work. At this time, the first electronic device 240 actively enters a normal (working) mode, and the connection state is online and the bus 250 supports hot-plug such that the driver of the second electronic device 260 can automatically support the first electronic device 240. In this status, the first electronic device 240 can be operated normally.

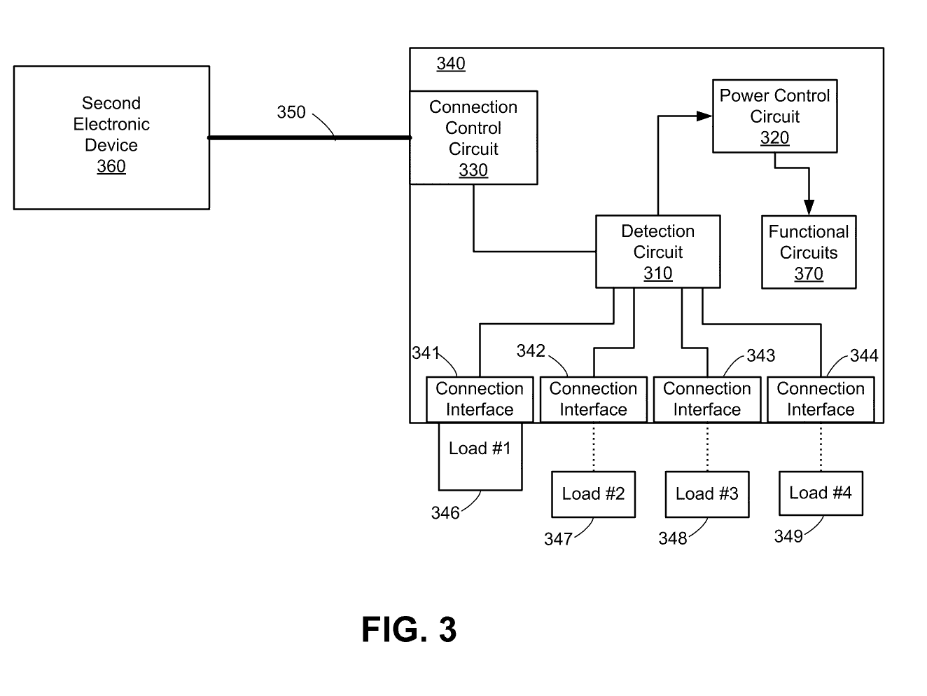

Hereafter, examples of embodiments of the present invention are given below for the purpose of further illustration. FIG. 3 is a schematic view of a power-saving device according to another embodiment of the present invention. In this embodiment, the first electronic device 340 is a multi-slotted card reader, connection interfaces 341 to 344 are various types of memory card slots, and loads 346 to 349 are various types of memory cards. For example, 341 is a CF card slot, and the corresponding load 346 is a CF card; 342 is an SM/xD card slot, and the corresponding load 347 is an SM/xD card; 343 is an SD/MMC card slot, and the corresponding load 348 is an SD/MMC card; and 344 is an MS/MSPRO/HG card slot, and the corresponding load 349 is an MS/MSPRO/HG card. In most embodiments, the second electronic device 360 is a computer, and thus the first electronic device 340 is a card reader. That is, the second electronic device 360 may be a computer system, and the first electronic device 340 may be a computer peripheral device.

In the second embodiment, the load state is generated according to a coupling state between the memory cards 345 to 349 and the connection interfaces 341 to 344. When the first electronic device 340 (card reader), detects that there is no load coupled thereto via the detection circuit 310 (i.e., the memory cards 345 to 349 are not inserted into the memory card slots 341 to 344), it is indicated that the first electronic device 340 is not required to work. At this time, the first electronic device 340 actively enters the power-saving mode, the power control circuit 320 controls the power provided by the second electronic device 360 (computer), and shuts down the circuit units in the first electronic device 340, and the connection control circuit 330 controls the bus 350 to disconnect from the second electronic device 360 such that the second electronic device 360 essentially sees the first electronic device 340 as disconnected. This means that the power-saving mode is realized by effectively disconnecting the first electronic device 340 from the second electronic device 360, and dynamic hot-plug is achieved by using hot-plug characteristics of the bus 350.

According to the power-saving mode of embodiments of the present invention, the first electronic device 340 is logically detached from the bus 350, and the second electronic device 360 considers that the first electronic device 340 has been disconnected, but in fact the first electronic device 340 is still coupled to the bus 350. At this time the first electronic device 340 is merely required to detect the load state (for example, whether any of the memory cards 346 to 349 are inserted into the memory card slots 341 to 344), and determine when to enter a working mode according to the load state. Being logically detached from the bus 350, the first electronic device 340 will not consume the power from the second electronic device 360, and is only required to maintain the detection circuit 310 in a working state to detect the load state, and the rest of the circuit units in the first electronic device 340 all enter a suspended state.

Moreover, in addition to the above embodiment in which the first electronic device 340 is a card reader and the load 346 is a memory card, various implementation aspects may also be adopted. For example, the first electronic device 340 may be a 10/100/Gigabit Ethernet device, and the corresponding load 346 may be a network line coupled to the network device. Therefore, the load state is generated according to the coupling state between a peripheral component (for example, the memory card or the network line—ie., the load 346), of the first electronic device 340 and the connection interface 341.

In the power-saving device of embodiments of the present invention, the power consuming problem is solved by the hardware device itself, so that the compatibility problem may not easily occur due to the utilization of software (i.e., a driver), as in the prior art. Further, according to embodiments of the present invention, only the detection circuit 310 remains in a working state after entering the power-saving mode, and the rest of the circuit units in the first electronic device 340 are in a low-power (e.g., a suspended, standby, or off) state, thereby consuming minimal or no power. Therefore, when the first electronic device 40 enters the power-saving mode (i,e., after the bus 50 is offline), it is discovered by experimentation that the consumed current, in some embodiments, is as low as a microamp (μA) level, and thus the power saving efficiency is significantly improved.

The first electronic device 340 further comprises a core or functional logic 370 to control the operation of the first electronic device 340. For example, the core logic may be a card reader controller if the first electronic device 340 is a card reader. The core logic is a CPU for a cell phone if the first electronic device 340 is a cell phone.

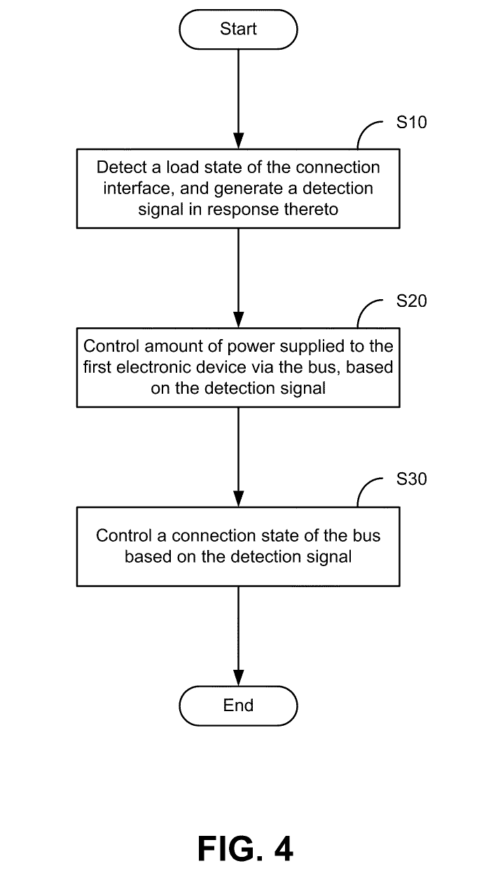

Having described various apparatus embodiments of the present invention, reference is now made to FIG. 4, which is a flow chart of a power saving method, according to an embodiment of the present invention. The illustrated power saving method is applicable to a first electronic device having at least one connection interface, and the first electronic device is coupled to a second electronic device via a bus. The method includes the following steps.

In step S10, a load state of the connection interface is detected, and a detection signal is generated. Specifically, in this step the load state is generated according to a coupling state between a coupled device (e.g., memory card) and the connection interface, or the load state is generated according to a coupling state between a peripheral component of the first electronic device and the connection interface.

In step S20, a power supplied to the first electronic device via the bus is controlled according to the detection signal. When the detection signal indicates that a device is coupled to the peripheral component, the a normal operating power is supplied to the circuitry of the peripheral component. However, when no device is coupled to the peripheral component (e.g., when there is no load placed on the peripheral component, then the functional circuitry of the first electronic device is place in a low-power mode of operation (e.g., standby or off).

In step S30, a connection state of the bus is controlled according to the detection signal. Specifically, in this step, when the load state is no-load, the connection state is controlled to be offline, or when the load state is load on, the connection state is controlled to be online.

The bus supports hot-plug, and may be a USB or a PCI-E. In addition, the second electronic device may be a computer system, and the first electronic device may be a computer peripheral device.

Though the present invention has been disclosed above by the preferred embodiments, they are not intended to limit the present invention. Persons skilled in the art can make some modifications and variations without departing from the spirit and scope of the present invention. Therefore, the protecting range of the present invention falls in the appended claims.

Indeed, various embodiments have been described above. It will be appreciated that certain features of the different embodiments may be combined with features of other embodiments, consistent with the scope and spirit of the present invention. For example, as described above, when the electronic device detects a no-load condition for an associated peripheral component, then power control logic disconnects power from on-board functional circuitry of the electronic device, thereby minimizing power requirements of the electronic device. In one embodiment, the connection control logic may place the bus in a low-power state, such that the electronic device appears to the host computer as being disconnected. In one embodiment, no power is drawn from the host computer across the bus to supply the detection circuit with continued power. Instead, such power is supplied by an on-board battery of the electronic device (or alternatively via a separate power adapter coupled to the electronic device). In other embodiments, the bus connecting the host computer with the electronic device may be placed in a low-power state which still allows minimal power to be drawn from the host computer (via the bus) to power the detection circuit.

What is claimed is:

1. An apparatus having at least one connection interface, wherein the apparatus is coupled to a electronic device via a bus, the apparatus comprising:
a detection circuit, coupled to the connection interface, to detect a load state of the connection interface and generate a detection signal;
a power control circuit, to control power modes of the apparatus in response to a state of the detection signal, wherein the power modes comprise a normal mode and a power-saving mode; and
a connection control circuit configured to control a connection state of the bus such that in response to the detection signal indicating a no-load state of the connection interface, the connection control circuits controls the connection state of the bus to make the apparatus appear to the electronic device as being detached.

2. The apparatus of claim 1, wherein when the load state is no-load, the connection state is offline.

3. The apparatus of claim 1, wherein when the load state is load on, the connection state is online.

4. The apparatus of claim 1, wherein the connection state is online when the connection interface is coupled to a peripheral component.

5. The apparatus of claim 1, wherein operational power for the apparatus is supplied by the electronic device.

6. The apparatus of claim 1, wherein the bus supports a hot-plug function.

7. The apparatus of claim 6, wherein the bus is one selected from the group consisting of: a Universal Serial Bus (USB), a Peripheral Component Interconnection (PCI), and a PCI-Express (PCI-E).

8. The apparatus of claim 1, wherein the electronic device is a host computer.

9. The apparatus of claim 1, wherein the connection control circuit comprises an interface circuit and a switch circuit.

10. A power saving method, applicable to a first electronic device having at least one connection interface for connecting the first electronic device to a peripheral component, the method comprising:
detecting a load state of the connection interface, and generating a detection signal in response thereto;
controlling a power mode of the first electronic device according to the detection signal, wherein the mode comprises a normal mode and a power-saving mode; and
controlling a connection state of a bus connecting the first electronic device to a second electronic device according to the detection signal, such that the connection state is changed in response to changing states of the detection signal, even though a physical connection of the first electronic device and second electronic device is maintained by the bus.

11. The method of claim 10, wherein the step of controlling the connection state of the bus comprises:
when the detected load state indicates a no-load condition, altering the connection state so that it is offline.

12. The method of claim 10, wherein the step of controlling the connection state of the bus comprises:
when the detected load state indicates a load condition, altering the connection state so that it is online.

13. The method of claim 10, wherein the step of detecting the load state of the connection interface comprises:
generating the load state according to a coupling state between a peripheral component of the first electronic device and the connection interface.

14. The method of claim 10, wherein the bus is one that supports a hot-plug function.

15. The method of claim 14, wherein the bus is one selected from the group consisting of: a Universal Serial Bus (USB), a Peripheral Component Interconnection (PCI), and a PCI-Express (PCI-E).

16. The method of claim 10, wherein the second electronic device is a host computer, and the first electronic device is a computer peripheral device.

17. An apparatus having at least one connection interface, wherein the apparatus is coupled to an electronic device via a bus, the apparatus comprising:
a detection circuit, coupled to the connection interface, to detect a load state of the connection interface and generate a detection signal in response thereto;
a power control circuit configured to control a power mode of the apparatus according to the detection signal, wherein the power mode is controlled between a normal mode and a power-saving mode; and
a connection control circuit configured to control a connection state of the bus in response to a state of the detection signal.

18. The apparatus of claim 17, wherein the connection control circuit further comprises:
an interface circuit, coupled to the bus, to communicate with the electronic device; and
a switch circuit, coupled to the bus, to control whether the interface circuit is coupled to the bus according to the detection signal.

19. An apparatus having at least one connection interface, wherein the apparatus is coupled to an electronic device via a bus, the apparatus comprising:
a detection circuit, coupled to the connection interface, to detect a load state of the connection interface and generate a detection signal in response to the detected load state;
a power control circuit, to control power supplied to circuitry within the apparatus in response to the detection signal; and
a connection control circuit, to control a connection state of the bus according to the detection signal.

20. A peripheral electronic device for coupling an electronic component to a host computer via a bus comprising:
a load detection circuit configured to detect whether the electronic component is connected to the peripheral electronic device;
a power control circuit configured to place functional circuitry of the peripheral electronic device in a low-power mode of operation in response to the load detection circuit determining that the electronic component is not connected to the peripheral electronic device; and
a connection control circuit configured to control a connection state of the bus in response to the load detection circuit determining that the electronic component is not connected to the peripheral electronic device.
